(19) United States
(12) Patent Application Publication
(10) Pub. No.: US 2024/0223574 A1
(43) Pub. Date: Jul. 4, 2024

(54) REAL TIME APPLICATION PROTECTION SYSTEM ATTACK MONITORING AND PATCHING

(71) Applicant: Wells Fargo Bank, N.A., San Francisco, CA (US)

(72) Inventors: Matthew Thomas McDonald, Callahan, FL (US); Jeremy W. Long, Herndon, VA (US); Mitch Moon, Plymouth, MN (US); Isaiah Adonu, Oro Valley, AZ (US)

(21) Appl. No.: 17/122,765

(22) Filed: Dec. 15, 2020

Related U.S. Application Data
(60) Provisional application No. 62/972,280, filed on Feb. 10, 2020.

(51) Int. Cl. H04L 29/06

(52) U.S. Cl. CPC H04L 63/1416; H04L 63/1433

(57) ABSTRACT

Techniques are described for improving real-time application protection (RTAP) systems (e.g., web application firewalls (WAFs), runtime application self-protection (RASP) systems). In particular, a device within a trusted network may be configured to monitor the RTAP systems. For example, the device may monitor network traffic to one or more application protection systems having one or more configuration settings; identify an attack in the network traffic that is blocked by a first application protection system having a first configuration setting; test the one or more configuration settings of the one or more application protection systems to determine whether each of the other application protection systems is configured to block the attack; in response to a determination being that at least one of the application protection systems is not configured to block the attack, generate an alert corresponding to an attack signature of the attack.

This application claims the benefit of U.S. Provisional Application No. 62/972,280, filed Feb. 10, 2020, the entire contents of which is incorporated herein by reference.

### TECHNICAL FIELD

This disclosure relates to computer systems and, in particular, application security for computer systems.

### BACKGROUND

Web applications are client-server computer programs in which client-side operations and user interface(s) run on a web browser. The server-side operations of web applications may be implemented by a computer network including a number of servers and computing devices. For example, a web application running on a server, accessed via a web browser, may communicate, via the Internet, with a database server of a computer network to access files or other information. In some instances, one or more real-time application protection systems may be deployed to monitor network data and identify data that may be malicious based on one or more configurations. For example, a web application firewall (WAF) system may filter, monitor, and block malicious data to and from a web application based on one or more configurations of the WAF. Similarly, a runtime application self-protection (RASP) system detects and reports or blocks malicious data based on one or more configurations of the RASP and runtime information of the web application. WAF or RASP systems may be commercial off-the-shelf systems that can be interacted with via one or more application programming interfaces (APIs). Configurations for one or more real-time application protection systems may be changed over time from the baseline configurations, which may leave the web applications vulnerable to potential network attacks.

### SUMMARY

In general, this disclosure describes computer systems for improving real-time application protection (RTAP) systems (e.g., web application firewalls (WAFs), runtime application self-protection (RASP) systems, and the like). RTAP systems may be commercial off-the-shelf systems that can be interacted with via one or more application programming interfaces (APIs).

In one example, the device may monitor network traffic to the RTAP systems and identify a blocked attack by a first configuration of a first RTAP system. The device may then determine whether the configurations of other RTAP systems within an enterprise network would also block the same attack. In response to determining that one or more other configurations would not block the same attack, the device may update the one or more configurations of the other RTAP systems to block the same attack. The device may also determine one or more known vulnerabilities associated with the attack type of the blocked attack and generate an alert about the one or more known vulnerabilities, test the plurality of configurations of the RTAP systems for the one or more known vulnerabilities, and/or prioritize configuration patches corresponding to the one or more known vulnerabilities. In this way, the device may help strengthen the protections of the RTAP systems through the enterprise network.

In another example, this disclosure is directed to a computer-implemented method including monitoring network traffic to one or more application protection systems having one or more configuration settings; identifying an attack in the network traffic that is blocked by a first application protection system having a first configuration setting of the one or more application protection systems having the one or more configuration settings; testing the one or more configuration settings of the one or more application protection systems to determine whether each of the other application protection systems is configured to block the attack; in response to a determination that at least one of the application protection systems is not configured to block the attack, generating an alert corresponding to an attack signature of the attack.

In another example, this disclosure is directed to a computer-readable medium storing instructions that, when executed by a computing system, cause one or more processors of the computing system to: monitor network traffic to one or more application protection systems having one or more configuration settings; identify an attack in the network traffic that is blocked by a first application protection system having a first configuration setting of the one or more application protection systems having the one or more configuration settings; test the one or more configuration settings of the one or more application protection systems to determine whether each of the other application protection systems is configured to block the attack; and in response to a determination being that at least one of the application protection systems is not configured to block the attack, generate an alert corresponding to an attack signature of the attack.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example computing system configured to monitor real-time application protection systems according to the techniques of this disclosure.

FIG. 2 is a block diagram illustrating an example set of components of a device configured to perform the techniques of this disclosure.

FIG. 3 is a flowchart illustrating an example method of monitoring configurations of real-time application protection systems according to the techniques of this disclosure.

### DETAILED DESCRIPTION

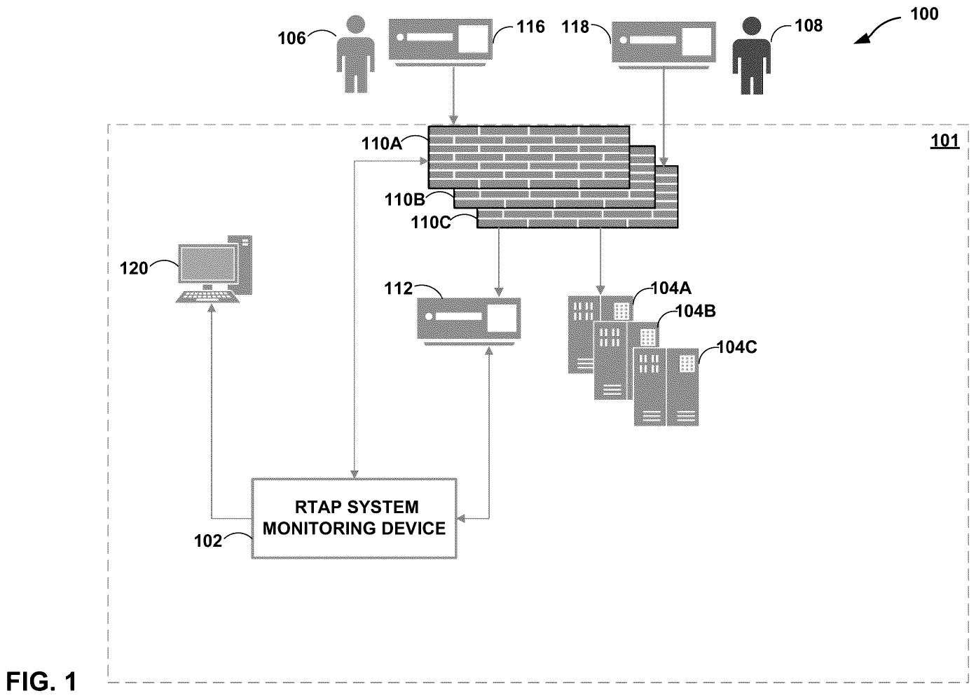

FIG. 1 is a block diagram illustrating an example computing system 100 configured to monitor real-time application protection (RTAP) systems 110A-110C (collectively, “RTAP systems 110”) according to the techniques of this disclosure. RTAP systems 110 may include web application firewalls (WAFs), runtime application self-protection (RASP) systems, and the like). RTAP systems 110 may be commercial off-the-shelf systems that can by interacted with via one or more application programming interfaces (APIs). For example, RTAP systems 110 may be configured or deployed through one or more APIs. Additionally, information from RTAP system 110 may be obtained through one or more APIs. In some examples, RTAP systems 110 may include deployed agents that may interacted with through a centralized server using an API.

In particular, system 100 includes a trusted network 101 that hosts web applications 104A-104C (collectively, “applications 104”). Trusted network 101 may be a computer network (e.g., a wide area network (WAN), such as the Internet, a local area network (LAN), or a virtual private network (VPN)), a telephone network (e.g., the PSTN or a wireless network), or another wired or wireless communication network. Although illustrated as a single entity, trusted network 101 may comprise a combination of multiple networks. Trusted network 101 also includes RTAP systems 110 that monitor network data into and out of applications 104 to identify data that may be malicious based on one or more configurations of the RTAP systems 110. In some examples, RTAP system 110A may correspond (e.g., monitor) application 104A, RTAP system 110B may correspond application 104B, and RTAP system 110C may correspond application 104C. For example, a computing device 116 operated by a user 106 may interact with application 104A (e.g., submit and obtain data from the application) while RTAP system 110A monitors the data traffic between the computing device 116 and application 104A. While three RTAP systems 110 and three applications 104 are shown in FIG. 1, system 100 may contain fewer or more RTAP systems 110 or applications 104. In another example, a computing device 118 operated by a malicious user 108 may attempt to submit malicious data or obtain data for which they are not authorized from application 104C (e.g., a denial of service attack, malicious HTTP POST/GET request, port scanning, a brute force attack) and RTAP system 110C may identify this malicious network traffic and block, report, and/or log it.

In some examples, computing device 116 and/or computing device 118 may be any suitable communication or computing device, such as a conventional or a mobile, non-mobile, wearable, and/or non-wearable computing device capable of communicating over network 18. For example, each of computing device 116, 118 may include any one or a combination of a conventional mobile phone, a smart phone, a smart watch, a tablet computer, a personal digital or virtual assistant, a gaming system, a media player, a smart television, an Internet of Things (IoT) device, an automobile or other vehicle, a laptop or notebook computer, a desktop computer, or any other type of wearable, non-wearable, mobile, and non-mobile computing device that may perform operations in accordance with one or more aspects of the present disclosure. One or more of computing device 116, 118 may support communication services over packet-switched networks, e.g., the public Internet, including Voice over Internet Protocol (VOIP).

In some examples, system 100 may include data monitoring device 112 that is configured to monitor, analyze, and/or search data or logs from RTAP systems 110 and/or application 104. For example, data monitoring device 112 may execute data monitoring or other security information and event management (SIEM) software that may capture, index, and correlate real-time data.

System 100 may further include a RTAP system monitoring device 102 configured to monitor RTAP systems 104. In general, RTAP system monitoring device 102 may comprise one or more computing devices, including servers, laptop or notebook computers, desktop computers, or any other type of computing devices that may perform operations in accordance with one or more aspects of the present disclosure.

In some examples, RTAP system monitoring device 102 may monitor network traffic to RTAP systems 110 to identify an attack in the network traffic that is blocked by an RTAP system (e.g., RTAP system 110A). RTAP system monitoring device 102 may test the plurality of configuration settings for the other RTAP systems (e.g., RTAP systems 110B and 110C) to determine whether each of these RTAP systems are configured to block the same attack. In response to a determination that one or more of the other RTAP systems would not block the attack, RTAP system monitoring device 102 may generate an alert corresponding to an attack signature of the attack and transmit the alert to security monitoring device 216. In some examples, the alert may include information about the attack (e.g., the attack signature associated with the attack or information about a vulnerability corresponding to the attack). In some examples, alerts may be communicated from RTAP system monitoring device 102 to other devices in the form of application-based alerts, email messages, text messages, or any other electronic communication. For example, an alert may be communicated in an email message, such as an emailed document or an emailed link. In some examples, the alert may be transmitted in XML format.

In some examples, RTAP system monitoring device 102 may also update (e.g., via an API) the configuration settings of the other RTAP systems to block the attack. In some examples, security monitoring device 116 may represent any type of computing devices that may be used by a user (e.g., desktop or laptop computer, tablet, a server, workstation). For example, security monitoring device 116 may be used by a system administrator of trusted network 101.

In some examples, RTAP system monitoring device 102 may determine known vulnerabilities associated with the attack type of the blocked attacked. In some examples, the alert may include these known vulnerabilities associated with the attack type. In some examples, RTAP system monitoring device 102 may test the plurality of configurations of RTAP systems 110 for these known vulnerabilities. In response to a determination that one or more of the configurations of RTAP systems 110 would not block one or more known vulnerabilities, RTAP system monitoring device 102 may receive one or more configuration patches corresponding to the one or more known vulnerabilities from a patch distribution server. In this way, RTAP system monitoring device 102 may help make RTAP systems 110 more secure.

In some examples, RTAP system monitoring device 102 may further prioritize configuration patches corresponding to the one or more known vulnerabilities. For example, the alert with information about the attack generated by RTAP system monitoring device 102 may further include information that indicates to prioritize configuration patches corresponding to the one or more known vulnerabilities, such as severity values for the one or more known vulnerabilities indicating the severity of the one or more known vulnerabilities. In some examples, RTAP system monitoring device 102 may generate and store a respective deadline for each vulnerability of the one or more known vulnerabilities. RTAP system monitoring device 102 may report the one or more known vulnerabilities and the respective deadlines to RTAP systems 110. RTAP systems 110 may determine whether there are compensating controls to mitigate the one or more known vulnerabilities. If RTAP systems 110 determine a compensation control for a specific vulnerability is missing, RTAP systems 110 may report the specific vulnerability to RTAP system monitoring device 102, and monitoring device 102 may adjust the deadline for the specific vulnerability to an earlier time than the stored deadline.

In general, configuration patches corresponding to the one or more known vulnerabilities are configured to modify the configurations of RTAP systems 110, including configurations of application programs, utility programs, operating systems and operating system components, device drivers, etc. RTAP system monitoring device 102 may request the one or more configuration patches corresponding to the one or more known vulnerabilities from a patch distribution server. Each configuration patch of the one or more configuration patches may contain a vulnerability identifier for identifying the corresponding known vulnerabilities addressed by the configuration patch. Upon receiving the one or more configuration patches, RTAP system monitoring device 102 may extract vulnerability identifiers from the one or more patches and prioritize the one or more configuration patches based on the vulnerability identifiers and the severity values included in the alert with information about the attack generated by RTAP system monitoring device 102.

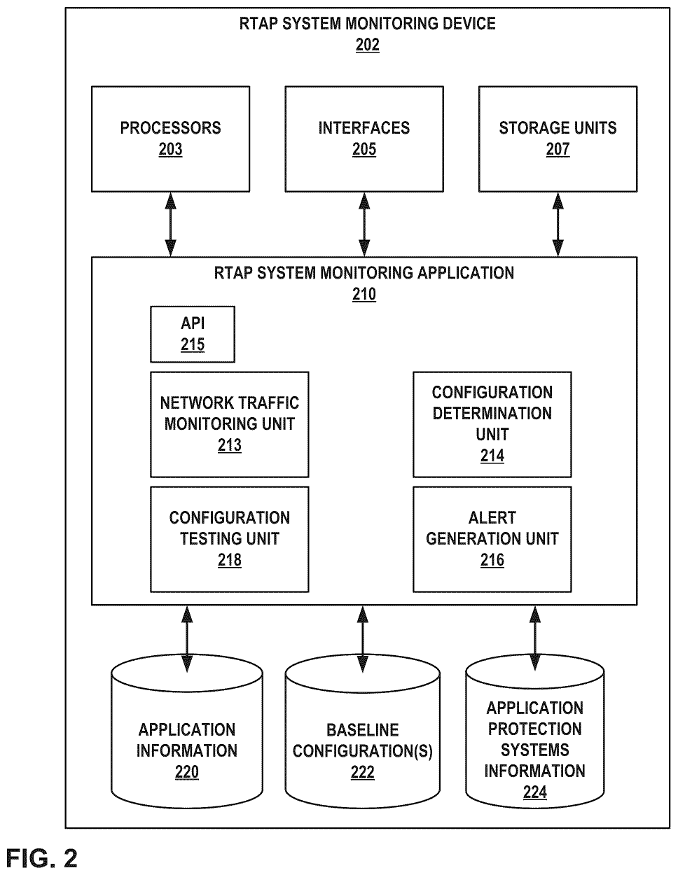

FIG. 2 is a block diagram illustrating an example set of components of a RTAP system monitoring device 202, which may be configured to perform the techniques of this disclosure. In the example of FIG. 2, RTAP system monitoring device 202 includes processors 203, interfaces 205, storage units 207, RTAP system monitoring application 210, application information 220, baseline configurations 222, and RTAP systems information 224. RTAP system monitoring application 210 further includes application programming interface (API) 215, network traffic monitoring unit 213, configuration determination unit 214, alert generating unit 216, and configuration testing unit 218. The components, units or modules of RTAP system monitoring device 202 are coupled (physically, communicatively, and/or operatively) using communication channels for inter-component communications. In some examples, the communication channels may include a system bus, a network connection, an inter-process communication data structure, or any other method for communicating data.

Processors 203, in one example, may comprise one or more processors that are configured to implement functionality and/or process instructions for execution within RTAP system monitoring device 202. For example, processors 203 may be capable of processing instructions stored by storage units 207. Processors 203 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Storage units 207 of RTAP system monitoring device 202 may store an operating system (not shown) executable by processors 203 to control the operation of components of RTAP system monitoring device 202. Storage units 207 may also be configured to store information within RTAP system monitoring device 202 during operation. Storage units 207 may include a computer-readable storage medium or computer-readable storage device. In some examples, storage units 207 include one or more of a short-term memory or a long-term memory. Storage units 207 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage units 207 are used to store program instructions for execution by processors 203. Storage units 207 may be used by software or applications running on RTAP system monitoring device 202 (e.g., RTAP system monitoring application 210) to temporarily store information during program execution.

Application information 220, baseline configurations 222, and RTAP systems information 224 represent one or more respective computer-readable storage media, which may be included within RTAP system monitoring device 202 as shown in the example of FIG. 2. Alternatively, one or more of application information 220, baseline configurations 222, and RTAP systems information 224 may be stored in one or more remote devices from which RTAP system monitoring device 202 may request data via interfaces 205 or API 215. The computer-readable storage media may be one or more of a hard disk, a flash drive, random access memory (RAM), or other such computer-readable storage media. Application information 220 may contain information about applications 104 including running status, testing status, and/or identification of individuals responsible for maintaining, updating, and/or testing each of applications 104. Baseline configurations 222 may contain the baseline configuration settings of each of RTAP systems 110. RTAP systems information 224 may include information about RTAP systems 110 including running status information, information about detected attacks, information about the application(s) each RTAP systems 110 is protecting.

RTAP system monitoring device 202 further includes RTAP system monitoring application 110, which may include API 215, network traffic monitoring unit 213, configuration determination unit 214, alert generating unit 216, and configuration testing unit 218. RTAP system monitoring device 202 may utilize interfaces 205 or API 215 to communicate with other systems or devices via one or more networks, e.g., RTAP systems 110 and/or defect data store 113 of FIG. 1. Interfaces 205 may be network interfaces (such as Ethernet interfaces, optical transceivers, radio frequency (RF) transceivers, Wi-Fi or Bluetooth radios, or the like), telephony interfaces, or any other type of devices that can send and receive information. In some examples, RTAP system monitoring application 210 utilizes interfaces 205 to wirelessly communicate with RTAP systems 110, applications 104 from FIG. 1. Although illustrated in FIG. 2 as including a single API 215, in other examples, RTAP system monitoring application 210 may include a plurality of APIs to pull data from one or more remote devices and/or interact with any of the other systems within trusted network 101 of FIG. 1.

In accordance with the techniques of this disclosure, network traffic monitoring unit 213 of RTAPS monitoring application 210 may monitor network traffic to RTAP systems 110 to identify an attack in the network traffic that is blocked by an RTAP system (e.g., RTAP system 110A). Configuration testing unit 218 may test the plurality of configuration settings for the other RTAP systems (e.g., RTAP systems 110B and 110C) to determine whether each of these other RTAP systems are configured to block the same attack. In some examples, configuration testing unit 218 may compare the configuration setting for the RTAP system that performed the block (e.g., RTAP system 110A) to the plurality of configuration settings for other RTAP systems (e.g., RTAP systems 110B and 110C) to determine whether each of these other RTAP systems could have preformed the block. In some examples, configuration testing unit 218 may push or upload the plurality of configuration settings for the RTAP systems (e.g., RTAP systems 110A, 110B and 110C) to a network device thereby configuring the device according to the plurality of configuration settings for the other RTAP systems and testing the plurality of configuration settings on the network device. In response to a determination that one or more of the other RTAP systems would not block the attack, alert generation unit 216 may generate an alert corresponding to an attack signature of the attack and transmit, via interfaces 205 or API 215, the alert to security monitoring device 216. In some examples, the alert may include information about the attack (e.g., the attack signature associated with the attack or information about a vulnerability corresponding to the attack). In some examples, configuration determination unit 214 may update (e.g., via an API) the configuration settings of the other RTAP systems to block the attack.

In some examples, configuration testing unit 218 may further determine known vulnerabilities associated the attack type of the blocked attacked. In some examples, alert generation unit 216 may include these knowns vulnerabilities associated with the attack type in its generated alerts. In some examples, configuration testing unit 218 may test the plurality of configurations of RTAP systems 110 for these known vulnerabilities. In response to a determination that one or more of the other configurations would not block one or more known vulnerabilities, configuration testing unit 218 may send a request for one or more configuration patches corresponding to the one or more known vulnerabilities to a patch distribution server and receive the one or more configuration patches from the patch distribution server. In this way, RTAP system monitoring device 202 may help make RTAP systems 110 more secure.

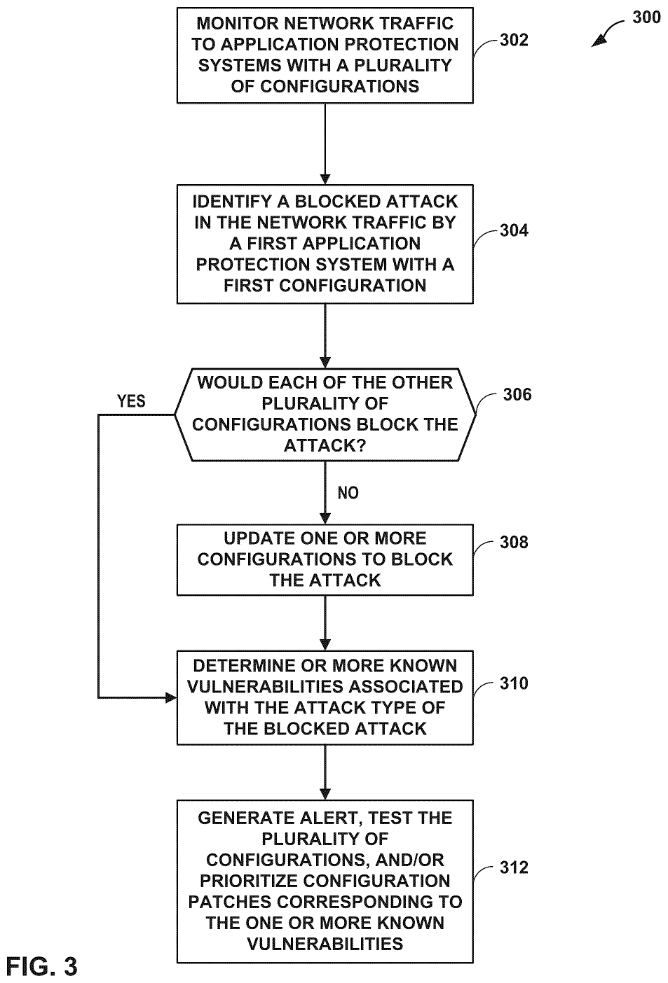

FIG. 3 is a flowchart 300 illustrating an example method of monitoring configurations of RTAP systems according to the techniques of this disclosure. For purposes of example and explanation, the method of FIG. 3 is explained with respect to RTAP system monitoring device 202 of FIG. 2. However, it should be understood that other computer devices may be configured to perform this or a similar method, including any of devices 102 or 202 of FIGS. 1-2.

RTAP system monitoring device 202 may monitor network traffic to and from RTAP systems (302). RTAP system monitoring device 202 may identify a blocked attack by a first RTAP system having a first protection (e.g., RTAP system 110A of FIG. 1) (304). RTAP system monitoring device 202 may then test the plurality of configuration settings corresponding to the other RTAP systems (e.g., RTAP systems 110B and 110C of FIG. 1) to determine whether each of these other configuration settings would cause the other RTAP systems to block the same attack (306). In response to a determination that one or more of the other configurations would not block the attack (NO branch of 306), RTAP system monitoring device 202 update, via an API, the configuration settings of the other RTAP systems to block the attack (308) and process 300 may continue to 310. In response to a determination that the other configurations would block the attack (YES branch of 306), RTAP system monitoring device 102 determines known vulnerabilities associated the attack type of the blocked attacked (310). RTAP system monitoring device 202 may then generate an alert corresponding to an attack signature of the blocked attack, test the plurality of configurations of all RTAP systems (e.g., RTAP systems 110) for these known vulnerabilities via an API, and/or prioritize configuration patches corresponding to the one or more known vulnerabilities (312). For example, RTAP system monitoring device 202 may generate an alert with information about the attack (e.g., the attack signature and/or attack type associated with the attack) and/or information about one or more vulnerabilities corresponding to the attack type. The alert may further indicate to prioritize configuration patches corresponding to the one or more known vulnerabilities. In some examples, RTAP system monitoring device 202 may test of the plurality of configurations for the known vulnerabilities by comparing the plurality of configurations (e.g., obtained through an API) against one or more known attack signatures associated with the one or more known vulnerabilities (e.g., obtained through an API).

The methods described above with respect to FIG. 3 may be performed by the same device (e.g., any of devices 102, 202, and/or any suitable computing device). Additionally, the components and functionality described above with respect to any of devices 102 and/or 202 may be combined into a single device that may implement all of the techniques of this disclosure.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described in this disclosure may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer-readable media may include non-transitory computer-readable storage media and transient communication media. Computer readable storage media, which is tangible and non-transitory, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer-readable storage media. It should be understood that the term “computer-readable storage media” refers to physical storage media, and not signals, carrier waves, or other transient media.

Various examples have been described. These and other examples are within the scope of the following claims.

1. A computer-implemented method comprising:
monitoring, by a monitoring device, network traffic to one or more application protection systems having one or more configuration settings, wherein the network traffic occurs between one or more user computing devices external to an enterprise network and one or more applications hosted by the enterprise network via at least one of the application protection systems, and wherein the application protection systems are configured to identify and block malicious network traffic from entering the enterprise network based on the configuration settings;
identifying, by the monitoring device, an attack in the network traffic that is blocked by a first application protection system of the enterprise network having a first configuration setting;
determining, by the monitoring device, one or more known vulnerabilities associated with a respective attack type corresponding to the attack;
based on the identification of the attack at the first application protection system, testing, by the monitoring device, configuration settings of one or more second application protection systems of the enterprise network to determine whether the one or more second application protection systems would block the attack that was blocked by the first application protection system regardless of whether the configuration settings of the one or more second application protection systems are the same as the first configuration settings of the first application protection system; and
in response to a determination that at least one of the one or more second application protection systems would not block the attack:
generating an alert corresponding to an attack signature of the attack, wherein the alert comprises the one or more known vulnerabilities associated with the respective attack type corresponding to the attack and one or more severity values for the one or more known vulnerabilities, each severity value indicating a severity of a particular vulnerability included in the one or more known vulnerabilities,
obtaining one or more configuration patches corresponding to the one or more known vulnerabilities,
extracting a vulnerability identifier from each of the one or more configuration patches, wherein each vulnerability identifier identifies at least one corresponding known vulnerability addressed by the respective configuration patch,
prioritizing the one or more configuration patches based on the extracted vulnerability identifier of each configuration patch and the severity value of the at least one corresponding known vulnerability identified by the vulnerability identifier, and
modifying portions of the configuration settings of the at least one of the one or more second application protection systems using the one or more configuration patches in an order based on the prioritization.

2-4. (canceled)

5. The method of claim 1, wherein testing the configuration settings of the one or more second application protection systems further comprises:
testing the one or more configuration settings of the one or more second application protection systems for the one or more known vulnerabilities.

6. The method of claim 1, wherein obtaining the one or more configuration patches comprises:
sending, by the monitoring device to a secondary device, one or more requests for the one or more configuration patches corresponding to the one or more known vulnerabilities; and
receiving, by the monitoring device from the secondary device, the one or more configuration patches corresponding to the one or more known vulnerabilities.

7. (canceled)

8. (canceled)

9. The method of claim 1, further comprising:
transmitting the alert to a secondary device.

10. A device comprising:
a memory; and
one or more processors implemented in circuitry and in communication with the memory, the one or more processors configured to:
monitor network traffic to one or more application protection systems having one or more configuration settings, wherein the network traffic occurs between one or more user computing devices external to an enterprise network and one or more applications hosted by the enterprise network via at least one of the application protection systems, and wherein the application protection systems are configured to identify and block malicious network traffic from entering the enterprise network based on the configuration settings;
identify an attack in the network traffic that is blocked by a first application protection system of the enterprise network having a first configuration setting;
determine one or more known vulnerabilities associated with a respective attack type corresponding to the attack;
based on the identification of the attack at the first application protection system, test configuration settings of one or more second application protection systems of the enterprise network to determine whether the one or more second application protection systems would block the attack that was blocked by the first application protection system regardless of whether the configuration settings of the one or more second application protection systems are the same as the first configuration settings of the first application protection system; and
in response to a determination that at least one of the one or more second application protection systems would not block the attack:
generate an alert corresponding to an attack signature of the attack, wherein the alert comprises the one or more known vulnerabilities associated with the respective attack type corresponding to the attack and one or more severity values for the one or more known vulnerabilities, each severity value indicating a severity of a particular vulnerability included in the one or more known vulnerabilities,
obtain one or more configuration patches corresponding to the one or more known vulnerabilities,
extract a vulnerability identifier from each of the one or more configuration patches, wherein each vulnerability identifier identifies at least one corresponding known vulnerability addressed by the respective configuration patch,
prioritize the one or more configuration patches based on the extracted vulnerability identifier of each configuration patch and the severity value of the at least one corresponding known vulnerability identified by the vulnerability identifier, and
modify portions of the configuration settings of the at least one of the one or more second application protection systems using the one or more configuration patches in an order based on the prioritization.

11-13. (canceled)

14. The device of claim 10, wherein, to test the one or more configuration settings of the one or more second application protection systems, the one or more processors are further configured to:
test the one or more configuration settings of the one or more second application protection systems for the one or more known vulnerabilities.

15. The device of claim 10, wherein to obtain the one or more configuration patches, the one or more processors are further configured to:
send, to a secondary device, one or more requests for the one or more configuration patches corresponding to the one or more known vulnerabilities; and
receive, from the secondary device, the one or more configuration patches corresponding to the one or more known vulnerabilities.

16. (canceled)

17. (canceled)

18. The device of claim 10, wherein the one or more processors are further configured to:
transmit the alert to a secondary device.

19. A computer-readable medium storing instructions that, when executed by a computing system, cause one or more processors of the computing system to:
monitor network traffic to one or more application protection systems having one or more configuration settings, wherein the network traffic occurs between one or more user computing devices external to an enterprise network and one or more applications hosted by the enterprise network via at least one of the application protection systems, and wherein the application protections systems are configured to identify and block malicious network traffic from entering the enterprise network based on the configuration settings;
identify an attack in the network traffic that is blocked by a first application protection system of the enterprise network having a first configuration setting;
determine one or more known vulnerabilities associated with a respective attack type corresponding to the attack;
based on the identification of the attack at the first application protection system, test the one or more configuration settings of one or more second application protection systems of the enterprise network to determine whether the one or more second application protection systems would block the attack that was blocked by the first application protection system regardless of whether the configuration settings of the one or more second application protection systems are the same as the first configuration settings of the first application protection system; and
in response to a determination that at least one of the one or more second application protection systems would not block the attack:
generate an alert corresponding to an attack signature of the attack, wherein the alert comprises the one or more known vulnerabilities associated with the respective attack type corresponding to the attack and one or more severity values for the one or more known vulnerabilities, each severity value indicating a severity of a particular vulnerability included in the one or more known vulnerabilities,
obtain one or more configuration patches corresponding to the one or more known vulnerabilities,
extract a vulnerability identifier from each of the one or more configuration patches, wherein each vulnerability identifier identifies at least one corresponding known vulnerability addressed by the respective configuration patch,
prioritize the one or more configuration patches based on the extracted vulnerability identifier of each configuration patch and the severity value of the at least one corresponding known vulnerability identified by the vulnerability identifier, and
modify portions of the configuration settings of the at least one of the one or more second application protection systems using the one or more configuration patches in an order based on the prioritization.

20. (canceled)
